(19) United States
(12) Patent Application Publication
(10) Pub. No.: US 2021/0365885 A1
(43) Pub. Date: Nov. 25, 2021

(54) CONCURRENT QUEUING AND DELIVERY IN AN ONLINE MARKETPLACE

(71) Applicant: eBay Inc., San Jose, CA (US)

(72) Inventor: Joshua Timonen, Portland, OR (US)

(21) Appl. No.: 16/879,113

(22) Filed: May 20, 2020

(51) Int. Cl. G06Q 10/08; G06Q 30/08; G06Q 50/30

(52) U.S. Cl. CPC G06Q 10/08345; G06Q 50/30; G06Q 30/08; G06Q 10/0835

(57) ABSTRACT

Embodiments of the subject technology provide a same day delivery system in an online marketplace. The subject technology receives, from a seller, data representing a window of time for which a pickup of a physical item occurs at a location of the seller for a delivery of the physical item to a location of a buyer. The subject technology determines a second location corresponding to a different delivery of a different physical item by a driver. The subject technology selects the driver, among a set of drivers, for delivery of the physical item where the driver is currently performing the different delivery of the different physical item when the driver is selected for the delivery of the physical item. Further, the subject technology adds the delivery in a queue of deliveries, the queue including the different delivery of the different physical item, for the driver during a particular day.

### TECHNICAL FIELD

An embodiment of the present subject matter relates generally to an online marketplace and, more specifically, to providing same day delivery in an online marketplace.

### BACKGROUND

Online marketplace services allow users to buy and sell items. For example, these services enable users to post listings offering items for sale, as well as view listings posted by other users.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows a system for same day delivery in an online marketplace, according to some example embodiments.

FIG. 2 is a block diagram of the same day delivery system, according to some example embodiments.

FIG. 3 illustrates example graphical interfaces (e.g., “interface”, “interfaces”, “interface”, or “UIs”) showing different stages for selecting a driver for same day delivery of an item, according to some example embodiments.

FIG. 4 illustrates example user interfaces (interface or UIs) showing different stages for indicating a completion of a same day delivery of an item according to some example embodiments.

FIG. 5 illustrates example user interfaces (interface or UIs) showing different stages for indicating a completion of a same day delivery of an item, according to some example embodiments.

FIG. 6 illustrates example user interfaces showing different stages for indicating a completion of a pickup of an item, according to some example embodiments.

FIG. 7 illustrates example user interfaces showing different stages related to a completion of a delivery of an item, according to some example embodiments.

FIG. 8 conceptually illustrate different examples of determining costs for a delivery for different drivers, and an example of queuing different deliveries for a driver in the same day, according to some example embodiments.

FIG. 9 is a flowchart showing a method of selecting a driver from a pool of available drivers in an online marketplace, according to some example embodiments.

FIG. 10 is a flowchart showing a method of determining total delivery costs and drop-off times based on a driver's rate and a distance to pick up an item from a seller in an online marketplace, according to some example embodiments.

FIG. 11 is a block diagram illustrating a representative software architecture, which may be used in conjunction with various hardware architectures herein described.

FIG. 12 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for providing same day delivery of items in an online marketplace. An online marketplace service allows users to buy and sell items online. For example, the online marketplace service allows users to post a listing to an online marketplace that lists an item for sale.

Embodiments of the subject technology relate to enabling drivers, via aspects of an auction platform provided by the online marketplace, to bid on performing same-day deliveries of items purchased in an online marketplace, as described further herein.

The subject system leverages aspects of the online marketplace to enable drivers, via a driver-side UI (e.g., client side), to specify a cost-per-unit of distance (e.g., a driver's rate) for performing same-day deliveries of items. The specified cost-per-unit of distance, in an example, determines what a given driver submits as a bid (e.g., a driver's cost for delivery) for performing same-day delivery of items purchased by buyers in an online marketplace. In a given delivery, the driver picks up the item at a seller's location, and then travels to a buyer's location to complete the delivery.

A driver is selected from a pool of drivers that are within a radius from a location of a seller of the physical item (recited in original proposed claim). Total delivery costs and drop-off times can be determined based on both a driver's rate and a distance to pick up an item from the seller. In this regard, the system enables a given driver, while possibly being further away, still being selected for a delivery based on a lower rate specified by the driver (and also meeting a desired delivery time as determined by the system). This advantageously provides a possibility of greater competition among drivers in the pool of drivers as further away drivers can set rates that are lower than other drivers closer to the seller's location for pick up of an item.

For a new delivery of an item, the system selects a driver from a pool of available drivers based on 1) the driver's proximity, starting from a location of a drop-off (e.g., delivery) of a previous transaction, to a seller's pick-up point for the new delivery, and 2) a window of time specified by the seller. The seller, as enabled by the system, can specify one or more periods of time in which a pickup can occur for an item. Moreover, the selected driver is one that is currently performing a different delivery of a different item when the driver is selected for the new delivery of the item.

In other aspects, the subject system provides verification mechanisms, using digital imaging means (e.g., QR code scanning) between respective client devices (e.g., mobile client devices of the driver and seller or buyer), for indicating pick-up from a seller and delivery of a given physical item to a buyer. Verification of delivery of the physical item using two respective mobile client devices enables the buyer of the delivered item to verify delivery by using a mobile device to scan the QR code displayed on the driver's mobile device.

Moreover, embodiments described herein provide a front-end user interface (“UI”) for the driver-side functionality, along with a front-end UI for the buyer-side functionality. Further, the aspects related to verification of pick-up and/or delivery of the physical item using mobile devices to scan QR codes involve situations between a driver and seller or buyer that leverage advantageous aspects of the subject technology to improve verification of various stages of the delivery process.

Although current services may provide delivery of physical items from a seller to a buyer, such services do not enable drivers to set their own rates per unit of distance, which would also enable buyers to select drivers based on their desired cost of such deliveries. Further, such services may not allow drivers to queue subsequent deliveries while on a current delivery. As a result, improvements to such services are disclosed as described further herein.

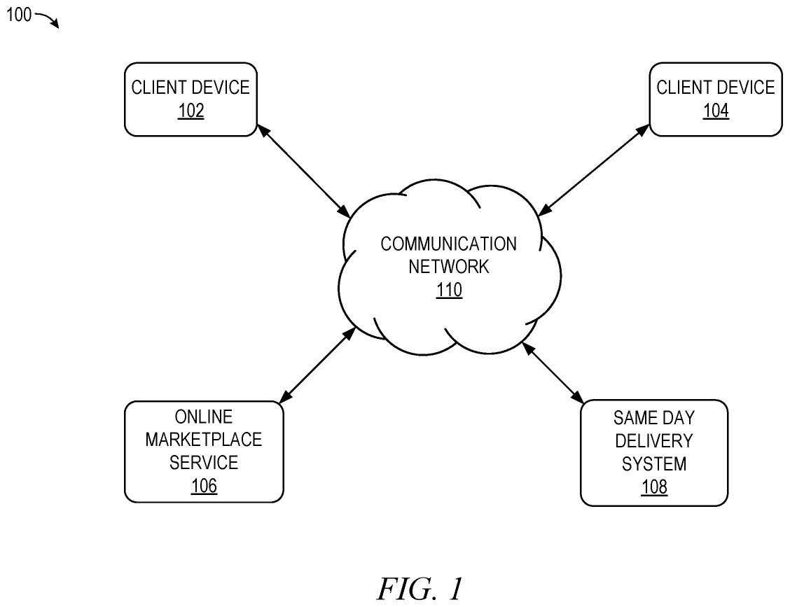

FIG. 1 shows a system 100 for providing same delivery of items in an online marketplace, according to some example embodiments. As shown, multiple devices (i.e., client device 102, client device 104, online marketplace service 106, and same day delivery system 108) are connected to a communication network 110 and configured to communicate with each other through use of the communication network 110. The communication network 110 is any type of network, including a local area network (LAN), such as an intranet, a wide area network (WAN), such as the internet, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

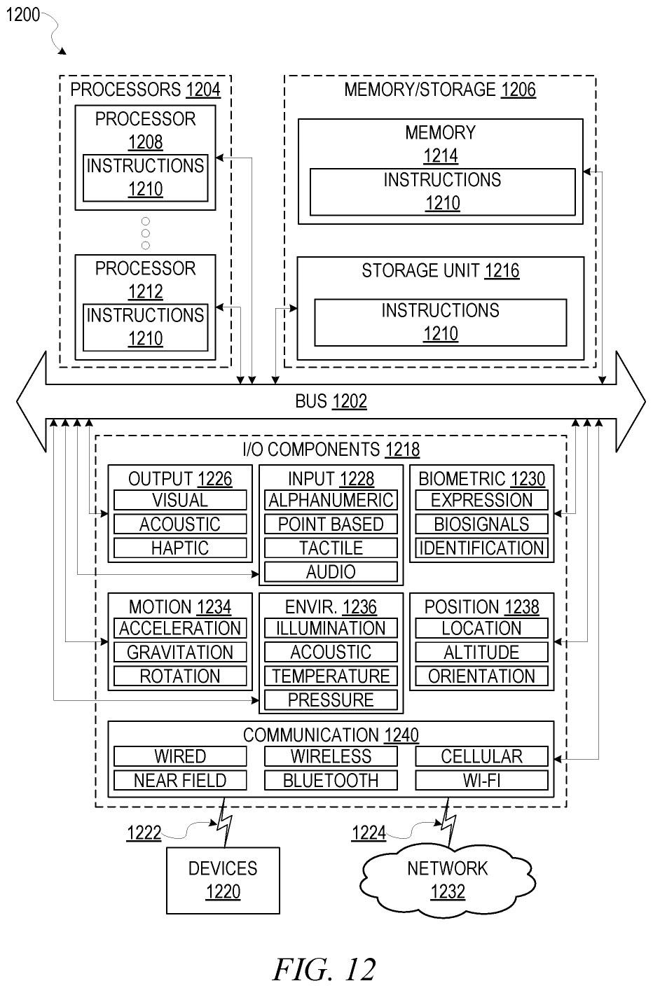

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 1200 shown in FIG. 12.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users interact with the online marketplace service 106 to utilize the services provided by the online marketplace service 106. The online marketplace service 106 provides an online marketplace in which users may post items for sale and purchase items posted for sale by other users. For example, the online marketplace service 106 may include items being auctioned for sale and/or items listed for sale at a set price. Users communicate with and utilize the functionality of the online marketplace service 106 by using the client devices 102 and 104 that are connected to the communication network 110 by direct and/or indirect communication.

Although the shown system 100 includes only two client devices 102, 104, this is only for ease of explanation and is not meant to be limiting. One skilled in the art would appreciate that the system 100 can include any number of client devices 102, 104. Further, the online marketplace service 106 may concurrently accept connections from and interact with any number of client devices 102, 104. The online marketplace service 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the online marketplace service 106 via a client-side application installed on the client devices 102 and 104. In some embodiments, the client-side application includes a component specific to the online marketplace service 106. For example, the component may be a stand-alone application, one or more application plug-ins, and/or a browser extension. However, the users may also interact with the online marketplace service 106 via a third-party application, such as a web browser, that resides on the client devices 102 and 104 and is configured to communicate with the online marketplace service 106. In either case, the client-side application presents a user interface (interface) for the user to interact with the online marketplace service 106. For example, the user interacts with the online marketplace service 106 via a client-side application integrated with the file system or via a webpage displayed using a web browser application.

The online marketplace service 106 is one or more computing devices configured to facilitate an online marketplace (e.g., EBAY, AMAZON, etc.) in which users may post items for sale and purchase items posted for sale by other users. For example, the online marketplace service 106 provides a user interface that enables users to view listings posted to the online marketplace service 106. Each listing provides details for an item or items listed for sale. For example, the listing may include an item description, images, sale price, current bid price, auction time remaining, shipping options, aspects, etc.

The online marketplace service 106 may further provide functionality that enables a user to purchase and/or bid on an item listed for sale. For example, the online marketplace service 106 may provide user interface elements (e.g., button, text fields, etc.) that a user may use to select to purchase an item, place a bid, etc., as well as provide their financial (e.g., credit card number, bank account number) and personal information (e.g., shipping address, billing address, etc.) to complete the purchase.

To list an item for sale on the online marketplace, a user creates a user account with the online marketplace service 106. The user account may include the user's personal information (e.g., name, address, email address, phone number, etc.) and financial information (e.g., credit card information, bank account information, etc.). Once the user has created a user account, the user may then use their user account to utilize the functionality of the online marketplace service 106, including listing an item for sale on the online marketplace.

The online marketplace service 106 provides users with a listing interface that enables a user to create a new listing as well as provide data for the listing. For example, the listing interface may include data fields that prompt the user to provide specified information for the listing, such as the total value (e.g., sale price), item description, listing title, images, shipping cost, return policy, aspects, etc. The listing interface may also include user interface elements, such as buttons, that enable the user to submit and/or post a completed listing. The user may post the listing after the user has filled in the data fields and provided images included in the listing interface.

An item listed for sale on the online marketplace may be listed for sale at a set sale price and/or as an auction. An item listed for sale at a set sale price may be purchased for the sale price while the listing for the item is active. For example, a user can select to purchase the listed item in exchange for payment of the set sale price.

In contrast, an item listed as an auction allows users an opportunity to submits offers (e.g., bids) for a specified duration of time, after which the auction ends. The user that submitted the highest offer prior to the end of the auction wins the listed auction, meaning that the winning user's offer to purchase the item is accepted by the seller. As a result, the winning user agrees to pay the offered amount in exchange for the listed item.

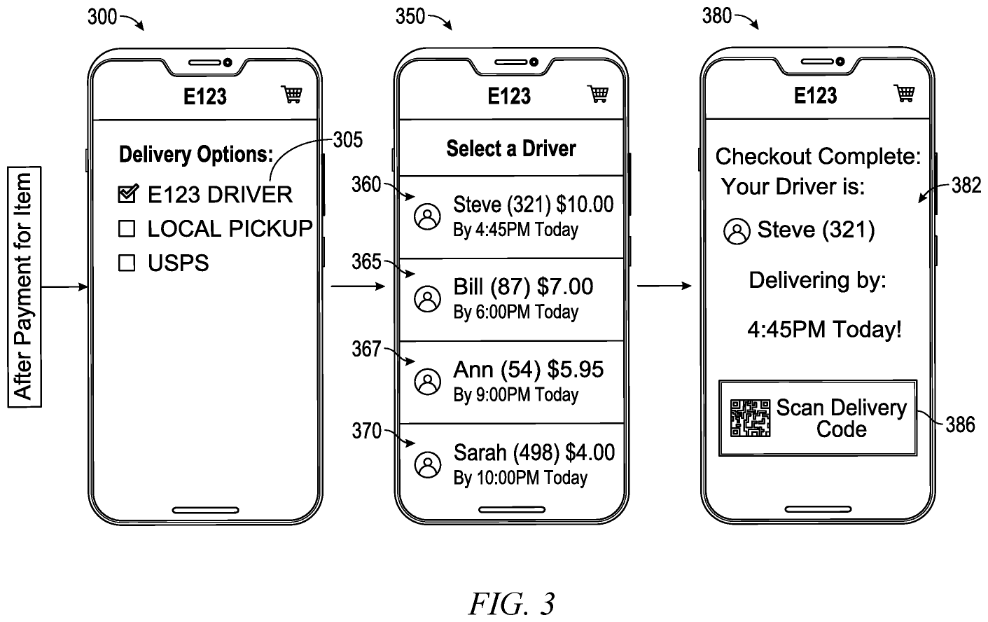

Whether purchasing the item based on the set sale price, or by winning the auction, the same day delivery system 108 enables a selection of a driver, from a pool of drivers, for delivering the item to the buyer's address (e.g., shipping or home address), which is described in further detail in FIG. 3 below. To be possibly selected for inclusion in the pool of drivers, a driver creates a driver account with the same day delivery system 108. The driver account may include the driver's personal information (e.g., name, address, email address, phone number, etc.), financial information (e.g., credit card information, bank account information, etc.), government credentials (e.g., driver's license, and the like), vehicle information (e.g., model, manufacturer, make, year, color, vehicle specifications, cargo space, number of seats for passengers, safety ratings, mileage, and the like), and driver rating and reviews.

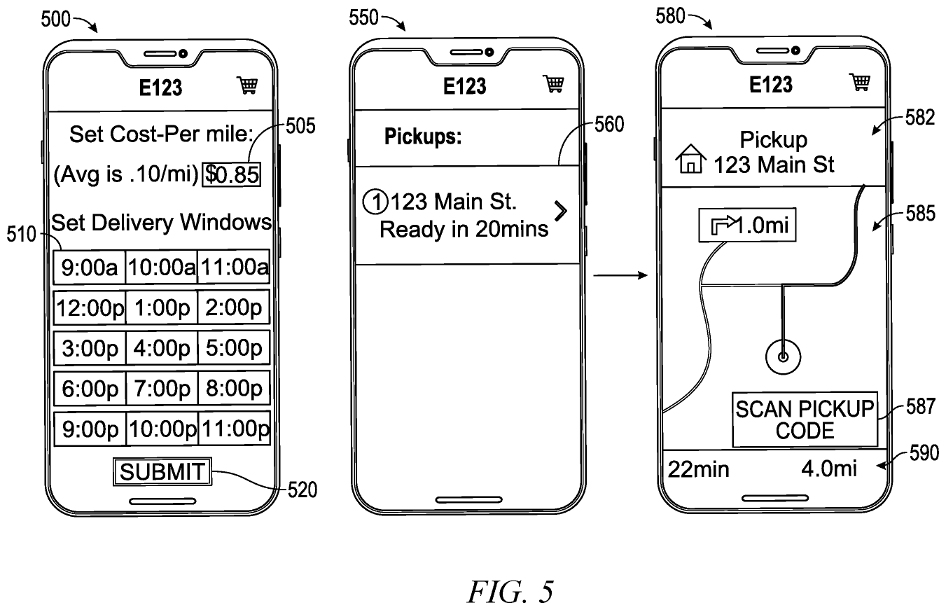

After the driver has created a driver account, the driver may then use the driver account to utilize the functionality of the online marketplace service 106, including submitting bids for completing deliveries for items offered for sale on the online marketplace. Moreover, the driver can use their driver account to set a rate per unit of distance (e.g., monetary cost over a specific distance metric), which is then utilized for the aforementioned bids for deliveries of items that have been purchased on the online marketplace (discussed in further detail in FIG. 5 below). Alternatively or conjunctively, the aforementioned driver account information may be stored by the online marketplace service 106.

In some embodiments, the online marketplace service 106 utilizes the same day delivery system 108 to facilitate same day deliveries of items. Although the same day delivery system 108 and the online marketplace service 106 are shown as separate entities, this is for the ease of explanation, without limitations. In some embodiments, the same day delivery system 108 can be included as part of the online marketplace service 106.

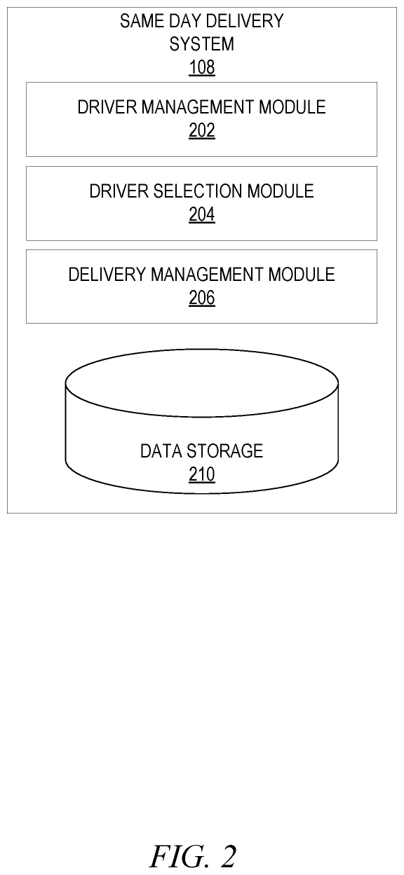

FIG. 2 is a block diagram of the same day delivery system 108, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the same day delivery system 108 to facilitate additional functionality that is not specifically described herein. Furthermore, the various functional modules depicted in FIG. 2 may reside on a single computing device or may be distributed across several computing devices in various arrangements such as those used in cloud-based architectures. For example, the various functional modules and components may be distributed amongst computing devices that facilitate both the same day delivery system 108 and the online marketplace service 106.

As shown, the same day delivery system 108 includes a driver management module 202, a driver selection module 204, a delivery management module 206, and a data storage 210.

The driver management module 202 determines a set of drivers for performing same day deliveries of respective items purchased from the online marketplace. Information related to the drivers may be stored in the data storage 210, which can be accessed by the driver management module 202.

The driver selection module 204 processes a selection a driver for a given same day delivery of an item purchased on the online marketplace service 106. For example, the driver selection module 204 may receive information in connection with a selection of a particular driver to assign to the same day delivery of the item (e.g., via a selection input from an interface that is sent to the driver selection module 204 discussed further in FIG. 3). Such information may include details regarding the same delivery (e.g., pickup address of the item and delivery address of the buyer). After determining the particular driver corresponding to the selection, the driver selection module 204 may obtain driver information associated with the driver from the data storage 210 and forward the driver information and the same day delivery information to the delivery management module 206 for additional processing.

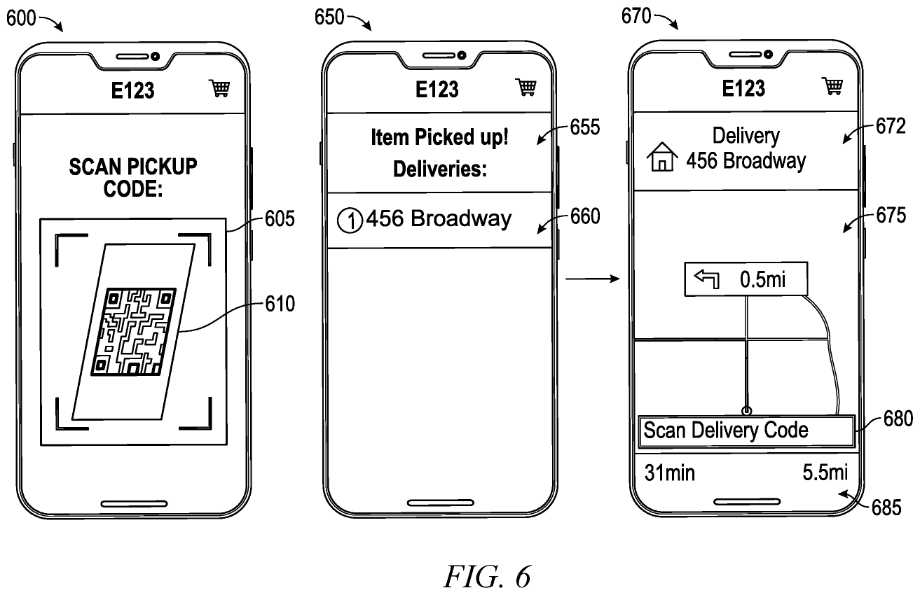

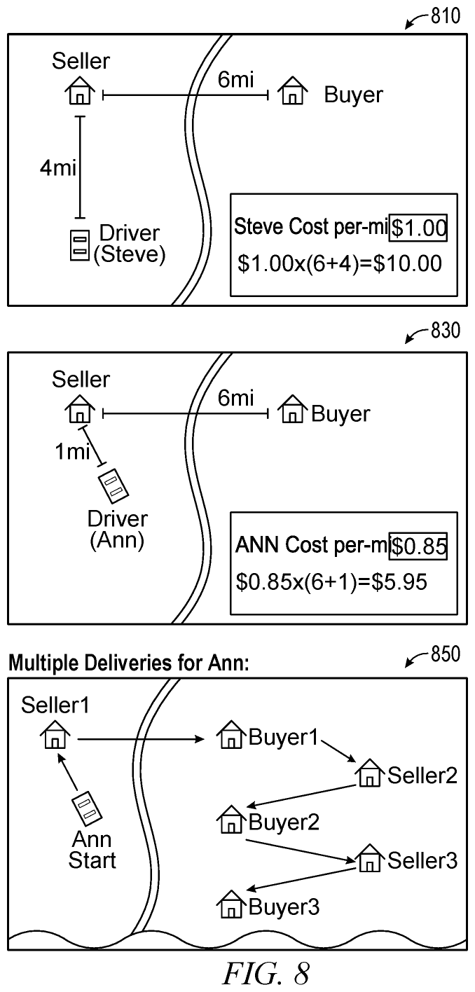

The delivery management module 206 manages same day deliveries of items purchased from the online marketplace. After receiving the information from the driver selection module 204 as discussed above, the delivery management module 206 can generate a delivery job for including in a list of same day deliveries for the driver. In an embodiment, the delivery management module 206 can generate a list of same day deliveries that the driver is to perform on the same day. In this regard, a same day delivery can include two respective addresses: 1) an address for a pickup of the item (e.g., corresponding to a seller), and 2) an address for delivery of the item (e.g., corresponding to a buyer). The delivery management module 206 can indicate, via a user interface, a set of pickups (e.g., illustrated in FIG. 5) and/or a set of delivery addresses (e.g., illustrated in FIG. 6). In an embodiment, the delivery management module 206 can queue multiple deliveries on the same day for a particular driver, which is discussed in further detail in FIG. 8.

FIG. 3 illustrates example graphical interfaces (e.g., “interface”, “interfaces”, “interface”, or “UIs”) showing different stages for selecting a driver for same day delivery of an item. The example interfaces of FIG. 3 can be provided for display on a client device (e.g., the client device 102 or the client device 104), such as through an interface(s) of a client application.

As illustrated, an interface 300 includes options for selecting a particular option for delivery. In this example, an option corresponding to a selectable graphical item 305 has been selected for same day delivery of an item.

An interface 350 shows another example interface after selection of the selectable graphical item 305. In this example, the same day delivery system 108 provides for display a set of drivers for including in the interface 350. Each driver shown in the interface 350 corresponds to selectable graphical area, such as selectable graphical area 360, selectable graphical area 365, selectable graphical area 367, and selectable graphical area 370. For a given selectable graphical area, information include a name of a driver, a rate of the driver, and a delivery time, among other types of information. Information related to respective drivers in the interface 350 may be listed or sorted (e.g., according to driver rate, driver name, delivery time, feedback score, and the like).

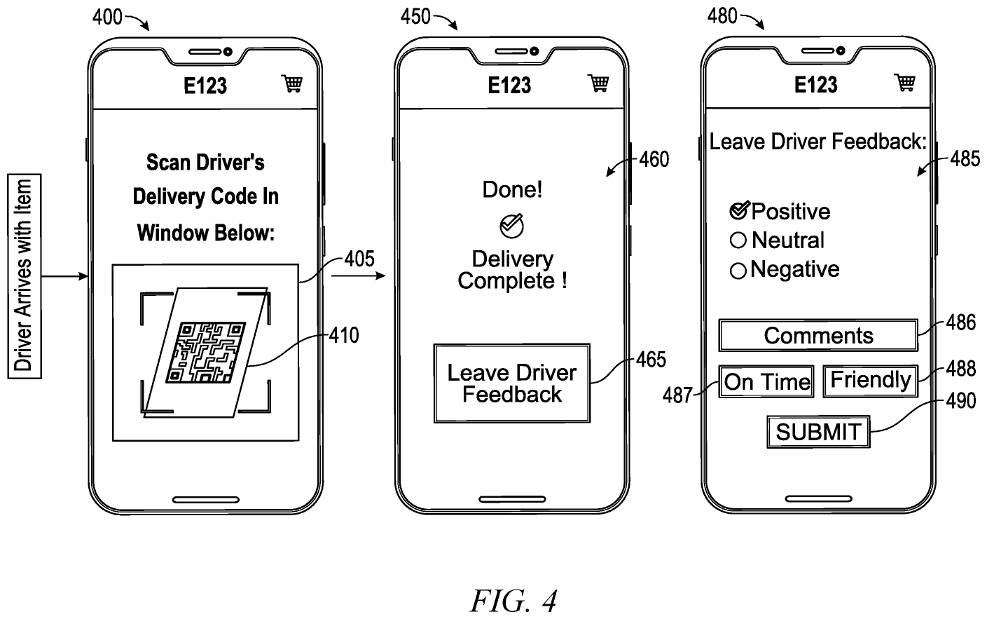

As further illustrated, an interface 380 includes an example interface indicating the result of selecting the driver as indicated in the selectable graphical area 360 in the interface 350. In the interface 380, information 382 includes a notification corresponding to the selected driver. The interface 380 also includes a selectable graphical item 386 for initiating a process for scanning a delivery code, which is discussed in further detail in FIG. 4 below. As referred to herein, a delivery code may be implemented as a barcode, Universal Product Code (UPC) code, QR code, other generated code (e.g., using digital or computing techniques), and the like.

FIG. 4 illustrates example user interfaces (interface or UIs) showing different stages for indicating a completion of a same day delivery of an item. The example interfaces of FIG. 4 can be provided for display on a client device (e.g., the client device 102 or the client device 104), such as through an interface(s) of a client application.

As illustrated, interface 400 includes a graphical border 405 around a representation 410 of a physical item including a driver code. In an example, a given client device (e.g., the client device 102 or the client device 104) may have at least one camera. Each camera may be, for example, a charge-coupled device (CCD), an active pixel sensor in complementary metal-oxide-semiconductor (CMOS) or N-type metal-oxide-semiconductor (NMOS), an infrared or ultrasonic image sensor, or an image sensor utilizing other type of image capturing technologies. In an example, the user can position the client device such that a physical object, such as a different client device displaying a driver code, is within a field of view of at least one camera of the client device, as shown in an interface 400. The at least one camera can capture an image, such that a representation of the driver code is displayed on a display screen of the client device. In some embodiments, the at least one camera captures video, providing a “live” view of the captured video information. The image or a frame of the video can be analyzed, such as by analyzing on the client device or sending across a network (e.g., the communication network 110) to a server or service (e.g., the same day delivery system 108 or the online marketplace service 106) for analyzing image data.

As further shown, interface 450 includes a notification 460 indicating that the delivery has been completed. The interface 450 includes a selectable graphical item 465 to leave feedback (e.g., a review or other qualitive information) for the driver.

In interface 480, a set of selectable graphical items 485 (e.g., positive, negative, and neutral) are included for providing feedback for the driver. In this example, a particular selectable graphical item corresponding to a positive feedback for the driver has been selected. As also shown, a selectable graphical item 486 for providing comments, a selectable graphical item 487 for indicating timeliness, and a selectable graphical item 488 indicating a friendly demeanor (e.g., positive customer service or interaction) are also provided in the interface 480. To submit the feedback to the system, a selectable graphical item 490 is provided in the interface 480.

In some embodiments, the same day delivery system 108 can enable a given driver to configure various windows of times for delivery, which may correspond to respective segments or divisions of time within a particular day.

FIG. 5 illustrates example user interfaces (interface or UIs) showing different stages for indicating a completion of a same day delivery of an item. The example interfaces of FIG. 5 can be provided for display on a client device (e.g., the client device 102 or the client device 104), such as through an interface(s) of a client application.

In some embodiments, in interface 500, a driver can set a rate per unit of distance (e.g., cost per mile, and the like) for a given delivery. As illustrated, a graphical item 505 can receive an input (e.g., text input) corresponding to input provided by a user (e.g., the driver) to configure a rate per unit of distance. As further shown, the interface 500 includes multiple selectable graphical items 510, in which each selectable graphical item corresponds to a respective time period (e.g., each hour from 9 am to 11 pm for the same day). It is appreciated that other time periods can be provided by the subject system, such as in half-hour time slots, and in some instances the interface may enable the user to input a specific or custom time period (e.g., 10:15 am to 11:05 am). A selectable graphical item 520 is also included in interface 500 for submitting the selected time periods to the same day delivery system 108.

After the rate has been configured and at least one time period has been selected, in interface 550, a list of at least one address 560 where the driver has a pickup of an item can be provided for display on the client device. Although only one pickup is illustrated in the interface 550, in some embodiments, additional pickups can be included in the interface 550 as more jobs are queued into the driver's set of deliveries for the day, which causes the interface 550 to be contemporaneously updated with such additional pickups.

As further shown, interface 580 includes a view of a map including at least a portion of a route that the driver can utilize to reach an address 582 corresponding to the address 560 included in the interface 550. In this example, the interface 580 includes an address 585 corresponding to a current job for pickup of an item and a trip status indicator 590 including information regarding an estimated amount of time and a distance until reaching the address 585. The interface 580 includes a selectable graphical item 587 for initiating functionality for scanning a pickup code that is provided by the seller of the item.

FIG. 6 illustrates example user interfaces (interface or UIs) showing different stages for indicating a completion of a pickup of an item. The example interfaces of FIG. 6 can be provided for display on a client device (e.g., the client device 102 or the client device 104), such as through an interface(s) of a client application.

As illustrated, interface 600 includes a graphical border 605 around a representation 610 of a physical item including a pickup code. As referred to herein, a pickup code may be implemented as a barcode, Universal Product Code (UPC) code, QR code, other generated code (e.g., using digital or computing techniques), and the like. In an example, a given client device (e.g., the client device 102 or the client device 104) may have at least one camera as described before. In an example, the user can position the client device such that a physical object, such as a different client device displaying a pickup code, is within a field of view of at least one camera of the client device, as shown in an interface 600. The at least one camera can capture an image, such that a representation of the pickup code is displayed on a display screen of the client device. In some embodiments, the at least one camera captures video, providing a “live” view of the captured video information. The image or a frame of the video can be analyzed, such as by analyzing on the client device or sending across a network (e.g., the communication network 110) to a server or service (e.g., the same day delivery system 108 or the online marketplace service 106) for analyzing image data.

As further shown, interface 650 includes a notification 655 indicating that the pickup of the item has been completed. The interface 650 includes a selectable graphical item 660 with an address for delivery of the item to the buyer.

As further shown, interface 670 includes a view of a map 675 including at least a portion of a route that the driver can utilize to reach the buyer's address (e.g., the delivery address) included in the interface 650. In this example, the interface 670 includes an address 672 corresponding to a current job for delivery of an item and a trip status indicator 685 including information regarding an estimated amount of time and a distance until reaching the address for delivery. The interface 670 includes a selectable graphical item 680 for initiating functionality for scanning a delivery code that is provided by the buyer of the item.

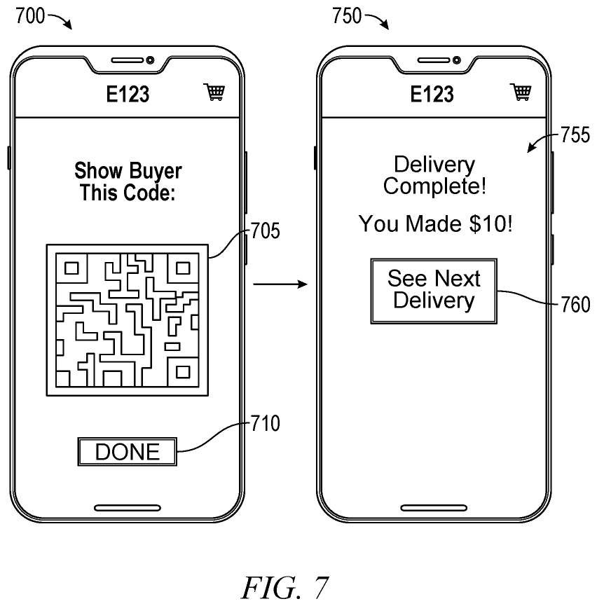

FIG. 7 illustrates example user interfaces (interface or UIs) showing different stages related to a completion of a delivery of an item. The example interfaces of FIG. 7 can be provided for display on a client device (e.g., the client device 102 or the client device 104), such as through an interface(s) of a client application. More specifically, the example interfaces in FIG. 7 may be displayed by a client device in possession with a driver performing the delivery of the item.

As illustrated, interface 700 includes a driver code 705 which may be presented to a buyer of the item for delivery that is being performed by the driver. After the buyer has scanned the driver code 705 (e.g., using a different client device in possession with the buyer), a different interface can be provided for display by the driver's client device to indicate that the delivery has been completed. As further shown, interface 700 includes a selectable graphical item 710, which when selected, sends a message to the same day delivery system 108 indicating that the delivery has been completed.

As further shown, interface 750 includes a notification 755 with an indication that the delivery has been completed and information including an amount of money that was entered by the driver from the completed delivery. In an example, such an amount of money can be based on the driver's rate (e.g., as discussed before in FIG. 5) and distance traveled in connection with completing the delivery. The interface 750 also includes a selectable graphical item 760 which upon selection can display a subsequent delivery of an item for the driver to perform.

In some embodiments, the same day delivery system 108 can determine respective costs for delivery for various drivers that are available for same day delivery of an item. Further, for a given driver, the same day delivery system 108 can queue multiple deliveries for items to schedule deliveries for the same day as discussed in further detail in FIG. 8.

FIG. 8 conceptually illustrate different examples of determining costs for a delivery for different drivers, and an example of queuing different deliveries for a driver in the same day.

In a first example 810, a map includes a starting location of a first driver (e.g., “Steve”), a distance to a seller of an item, and a distance to a buyer of the item. A rate for the driver is further shown in the example 810. The same day delivery system 108 can determine a cost for the delivery of the item using a sum of the distance to the seller and the distance to the buyer, which are then multiplied by the first driver's rate.

In a second example 830, a map includes a starting location of a second driver (e.g., “Ann”), a distance to a seller of an item, and a distance to a buyer of the item. A rate for the second driver is further shown in the example 830. The same day delivery system 108 can determine a cost for the delivery of the item using a sum of the distance to the seller and the distance to the buyer, which are then multiplied by the second driver's rate.

Although the cost for delivery for the driver in example 810 is more than the cost for delivery for the second driver in example 830, it is appreciated that the first driver in example 810 can set a different rate lower than the second driver in example 830 to reduce the cost of delivery and thereby making the first driver more likely to be assigned to the delivery of the item (e.g., by being selected by the buyer of the item).

As further illustrated, a map includes an example 850 of scheduling different deliveries for a particular driver. In example 850, three deliveries of items are shown in the map which the same day delivery system 108 has queued for the driver to perform in the same day. The three deliveries on the same day includes a first delivery from the driver's starting location to a first seller (“Seller 1”) and continuing to a first buyer (“Buyer 1”), a second delivery from the first buyer to a second seller (“Seller 2”) and then to a second buyer (“Buyer 2”), and a third delivery from the second buyer to a third seller (“Seller 3’) and then to a third buyer (“Buyer 3”). In example 850, each time the driver may be included in a list of available drivers, the starting point of the driver is the last drop off location (e.g., corresponding to a respective buyer) in the queue of deliveries. In an example in which the driver's queue is empty when outside of the driver's delivery time periods, the same day delivery system 108 can utilize the driver's home or default address as the driver's starting point (or current location). Alternatively, if the driver's queue is empty and within the driver's delivery time periods, the driver's current location can be utilized as the starting point.

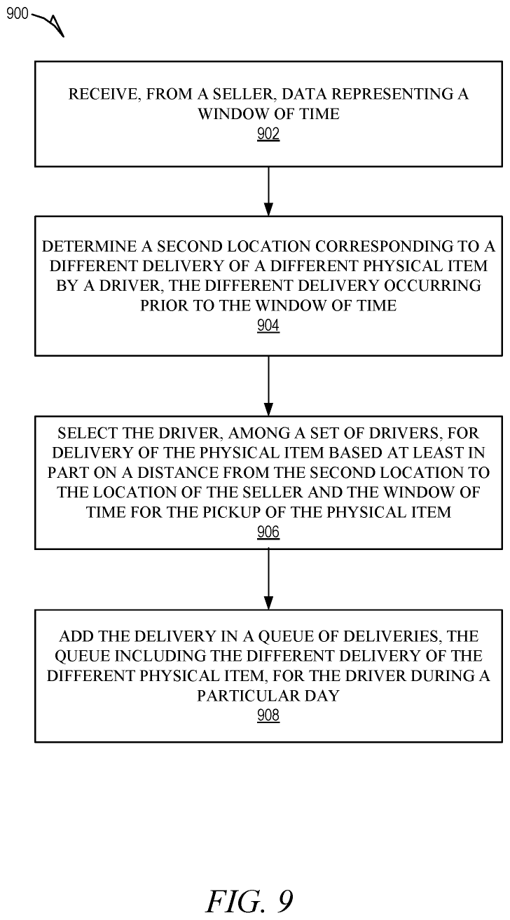

FIG. 9 is a flowchart showing a method of selecting a driver from a pool of available drivers in an online marketplace, according to some example embodiments. The method 900 may be embodied in computer readable instructions for execution by one or more processors such that the operations of the method 900 may be performed in part or in whole by the same day delivery system 108; accordingly, the method 900 is described below by way of example with reference thereto. However, it shall be appreciated that at least some of the operations of the method 900 may be deployed on various other hardware configurations and the method 900 is not intended to be limited to the same day delivery system 108.

At operation 902, the delivery management module 206 receives, from a seller, data representing a window of time, the window of time including one or more periods of time for which a pickup of a physical item occurs at a location of the seller for a delivery of the physical item to a location of a buyer.

At operation 904, the delivery management module 206 determines a second location corresponding to a different delivery of a different physical item by a driver, the different delivery occurring prior to the window of time.

At operation 906, the driver selection module 204 selects the driver, among a set of drivers, for delivery of the physical item based at least in part on a distance from the second location to the location of the seller and the window of time for the pickup of the physical item. In an embodiment, the driver is currently performing the different delivery of the different physical item when the driver is selected for the delivery of the physical item. Further, each driver from the set of drivers has submitted a respective bid, corresponding to a respective cost for delivery, for delivery of the physical item. The respective bid associated with the driver therefore has been selected to perform delivery of the physical item.

To facilitate selection of a particular driver, for each driver from the set of drivers, the driver management module 202 determines a particular location corresponding to a particular delivery of a particular physical item, the particular delivery occurring prior to the window of time. The driver management module 202 then determines a respective distance from the particular location to the location of the seller.

At operation 908, the delivery management module 206, in response to selecting the driver, adds the delivery in a queue of deliveries, the queue including the different delivery of the different physical item, for the driver during a particular day.

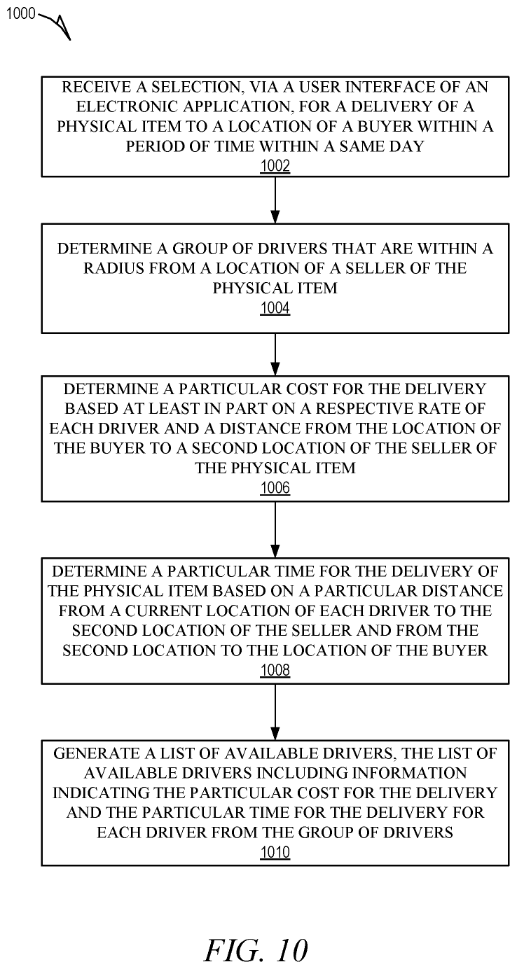

FIG. 10 is a flowchart showing a method of determining total delivery costs and drop-off times based on a driver's rate and a distance to pick up an item from a seller in an online marketplace, according to some example embodiments. The method 1000 may be embodied in computer readable instructions for execution by one or more processors such that the operations of the method 1000 may be performed in part or in whole by the same day delivery system 108; accordingly, the method 1000 is described below by way of example with reference thereto. However, it shall be appreciated that at least some of the operations of the method 1000 may be deployed on various other hardware configurations and the method 1000 is not intended to be limited to the same day delivery system 108.

At operation 1002, the delivery management module 206 receives a selection, via a user interface of an electronic application, for a delivery of a physical item to a location of a buyer within a period of time within a same day.

At operation 1004, the driver management module 202 determines a group of drivers that are within a radius from a location of a seller of the physical item.

At operation 1006, the driver management module 202 determines a particular cost for the delivery based at least in part on a respective rate of each driver and a distance from the location of the buyer to a second location of the seller of the physical item.

At operation 1008, the driver management module 202 determines a particular time for the delivery of the physical item based on a particular distance from a current location of each driver to the second location of the seller and from the second location to the location of the buyer.

At operation 1010, the driver management module 202 generates a list of available drivers, the list of available drivers including information indicating the particular cost for the delivery and the particular time for the delivery for each driver from the group of drivers. In an embodiment, the driver management module 202 causes, in the user interface of the electronic application (e.g., a client application running on a client device), a display of the list of available drivers.

In an embodiment, for each driver from the group of drivers, the driver management module 202 determines a particular time for a pickup of the physical item at the second location of the seller based at least in part on the current location of each driver, and includes the particular time for the pickup of the physical item as additional information in the list of available drivers.

Further, the driver selection module 204 receives a second selection of one of the available drivers in the list of available drivers, sends a request for fulfilling the delivery to the one of the available drivers, and receives a message confirming the request.

Software Architecture

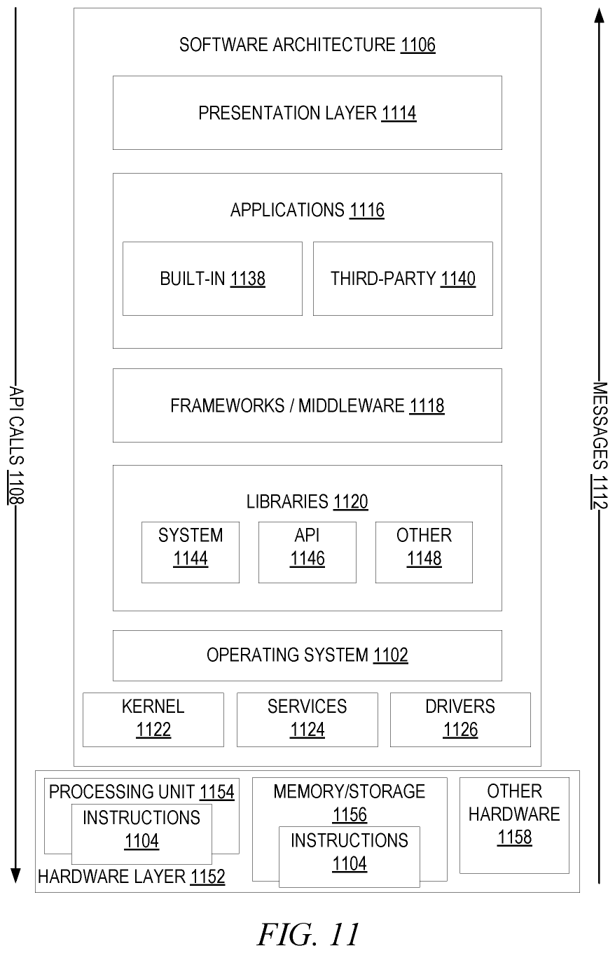

FIG. 11 is a block diagram illustrating an example software architecture 1106, which may be used in conjunction with various hardware architectures herein described. FIG. 11 is a non-limiting example of a software architecture 1106 and it will be appreciated that many other architectures may be implemented to facilitate the functionality described herein. The software architecture 1106 may execute on hardware such as machine 1200 of FIG. 12 that includes, among other things, processors 1204, memory 1214, and (input/output) I/O components 1218. A representative hardware layer 1152 is illustrated and can represent, for example, the machine 1200 of FIG. 12. The representative hardware layer 1152 includes a processing unit 1154 having associated executable instructions 1104. Executable instructions 1104 represent the executable instructions of the software architecture 1106, including implementation of the methods, components, and so forth described herein. The hardware layer 1152 also includes memory and/or storage modules 1156, which also have executable instructions 1104. The hardware layer 1152 may also comprise other hardware 1158.

In the example architecture of FIG. 11, the software architecture 1106 may be conceptualized as a stack of layers where each layer provides particular functionality. For example, the software architecture 1106 may include layers such as an operating system 1102, libraries 1120, frameworks/middleware 1118, applications 1116, and a presentation layer 1114. Operationally, the applications 1116 and/or other components within the layers may invoke Application Programming Interface (API) calls 1108 through the software stack and receive a response such as messages 1112 in response to the API calls 1108. The layers illustrated are representative in nature and not all software architectures have all layers. For example, some mobile or special purpose operating systems may not provide a frameworks/middleware 1118, while others may provide such a layer. Other software architectures may include additional or different layers.

The operating system 1102 may manage hardware resources and provide common services. The operating system 1102 may include, for example, a kernel 1122, services 1124, and drivers 1126. The kernel 1122 may act as an abstraction layer between the hardware and the other software layers. For example, the kernel 1122 may be responsible for memory management, processor management (e.g., scheduling), component management, networking, security settings, and so on. The services 1124 may provide other common services for the other software layers. The drivers 1126 are responsible for controlling or interfacing with the underlying hardware. For instance, the drivers 1126 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 1120 provide a common infrastructure that is used by the applications 1116 and/or other components and/or layers. The libraries 1120 provide functionality that allows other software components to perform tasks in an easier fashion than to interface directly with the underlying operating system 1102 functionality (e.g., kernel 1122, services 1124, and/or drivers 1126). The libraries 1120 may include system libraries 1144 (e.g., C standard library) that may provide functions such as memory allocation functions, string manipulation functions, mathematical functions, and the like. In addition, the libraries 1120 may include API libraries 1146 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1120 may also include a wide variety of other libraries 1148 to provide many other APIs to the applications 1116 and other software components/modules.

The frameworks/middleware 1118 (also sometimes referred to as middleware) provide a higher-level common infrastructure that may be used by the applications 1116 and/or other software components/modules. For example, the frameworks/middleware 1118 may provide various graphical user interface (GUI) functions, high-level resource management, high-level location services, and so forth. The frameworks/middleware 1118 may provide a broad spectrum of other APIs that may be used by the applications 1116 and/or other software components/modules, some of which may be specific to a particular operating system 1102 or platform.

The applications 1116 include built-in applications 1138 and/or third-party applications 1140. Examples of representative built-in applications 1138 may include, but are not limited to, a contacts application, a browser application, a book reader application, a location application, a media application, a messaging application, and/or a game application. Third-party applications 1140 may include an application developed using the ANDROID™ or IOS™ software development kit (SDK) by an entity other than the vendor of the particular platform, and may be mobile software running on a mobile operating system such as IOS™ ANDROID™, WINDOWS® Phone, or other mobile operating systems. The third-party applications 1140 may invoke the API calls 1108 provided by the mobile operating system (such as operating system 1102) to facilitate functionality described herein.

The applications 1116 may use built in operating system functions (e.g., kernel 1122, services 1124, and/or drivers 1126), libraries 1120, and frameworks/middleware 1118 to create UIs to interact with users of the system. Alternatively, or additionally, in some systems, interactions with a user may occur through a presentation layer, such as presentation layer 1114. In these systems, the application/component “logic” can be separated from the aspects of the application/component that interact with a user.

FIG. 12 is a block diagram illustrating components of a machine 1200, according to some example embodiments, able to read instructions 1104 from a machine-readable medium (e.g., a machine-readable storage medium) and perform any one or more of the methodologies discussed herein. Specifically, FIG. 12 shows a diagrammatic representation of the machine 1200 in the example form of a computer system, within which instructions 1210 (e.g., software, a program, an application, an applet, an app, or other executable code) for causing the machine 1200 to perform any one or more of the methodologies discussed herein may be executed. As such, the instructions 1210 may be used to implement modules or components described herein. The instructions 1210 transform the general, non-programmed machine 1200 into a particular machine 1200 programmed to carry out the described and illustrated functions in the manner described. In alternative embodiments, the machine 1200 operates as a standalone device or may be coupled (e.g., networked) to other machines. In a networked deployment, the machine 1200 may operate in the capacity of a server machine or a client machine in a server-client network environment, or as a peer machine in a peer-to-peer (or distributed) network environment. The machine 1200 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 1200 capable of executing the instructions 1210, sequentially or otherwise, that specify actions to be taken by machine 1200. Further, while only a single machine 1200 is illustrated, the term “machine” shall also be taken to include a collection of machines that individually or jointly execute the instructions 1210 to perform any one or more of the methodologies discussed herein.

The machine 1200 may include processors 1204, memory/storage 1206, and I/O components 1218, which may be configured to communicate with each other such as via a bus 1202. The memory/storage 1206 may include a memory 1214, such as a main memory, or other memory storage, and a storage unit 1216, both accessible to the processors 1204 (e.g., processor 1208, processor 1212) such as via the bus 1202. The storage unit 1216 and memory 1214 store the instructions 1210 embodying any one or more of the methodologies or functions described herein. The instructions 1210 may also reside, completely or partially, within the memory 1214, within the storage unit 1216, within at least one of the processors 1204 (e.g., within the processor's cache memory), or any suitable combination thereof, during execution thereof by the machine 1200. Accordingly, the memory 1214, the storage unit 1216, and the memory of processors 1204 are examples of machine-readable media.

The I/O components 1218 may include a wide variety of components to receive input, provide output, produce output, transmit information, exchange information, capture measurements, and so on. The specific I/O components 1218 that are included in a particular machine 1200 will depend on the type of machine. For example, portable machines such as mobile phones will likely include a touch input device or other such input mechanisms, while a headless server machine will likely not include such a touch input device. It will be appreciated that the I/O components 1218 may include many other components that are not shown in FIG. 12. The I/O components 1218 are grouped according to functionality merely for simplifying the following discussion and the grouping is in no way limiting. In various example embodiments, the I/O components 1218 may include output components 1226 and input components 1228. The output components 1226 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1228 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1218 may include biometric components 1230, motion components 1234, environmental components 1236, or position components 1238 among a wide array of other components. For example, the biometric components 1230 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1234 may include acceleration sensor components (e.g., accelerometer), gravitation sensor components, rotation sensor components (e.g., gyroscope), and so forth. The environmental components 1236 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1238 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1218 may include communication components 1240 operable to couple the machine 1200 to a network 1232 or devices 1220 via coupling 1224 and coupling 1222, respectively. For example, the communication components 1240 may include a network interface component or other suitable device to interface with the network 1232. In further examples, communication components 1240 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1220 may be another machine or any of a wide variety of peripheral devices (e.g., a peripheral device coupled via a USB).

Moreover, the communication components 1240 may detect identifiers or include components operable to detect identifiers. For example, the communication components 1240 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1240, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 1210 for execution by the machine 1200, and includes digital or analog communications signals or other intangible medium to facilitate communication of such instructions 1210. Instructions 1210 may be transmitted or received over the network 1232 using a transmission medium via a network interface device and using any one of a number of well-known transfer protocols.

“CLIENT DEVICE” in this context refers to any machine 1200 that interfaces to a communications network 1232 to obtain resources from one or more server systems or other client devices. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 1232.

“COMMUNICATIONS NETWORK” in this context refers to one or more portions of a network 1232 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 1232 or a portion of a network 1232 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 1210 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 1210. The term “machine-readable medium” shall also be taken to include any medium, or combination of multiple media, that is capable of storing instructions 1210 (e.g., code) for execution by a machine 1200, such that the instructions 1210, when executed by one or more processors 1204 of the machine 1200, cause the machine 1200 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors 1204) may be configured by software (e.g., an application 1116 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 1204 or other programmable processor 1204. Once configured by such software, hardware components become specific machines 1200 (or specific components of a machine 1200) uniquely tailored to perform the configured functions and are no longer general-purpose processors 1204. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 1204 configured by software to become a special-purpose processor, the general-purpose processor 1204 may be configured as respectively different special-purpose processors (e.g., comprising different hardware components) at different times. Software accordingly configures a particular processor or processors 1204, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 1202) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 1204 that are temporarily configured (e.g., by software) or permanently configured to perform the relevant operations. Whether temporarily or permanently configured, such processors 1204 may constitute processor-implemented components that operate to perform one or more operations or functions described herein. As used herein, “processor-implemented component” refers to a hardware component implemented using one or more processors 1204. Similarly, the methods described herein may be at least partially processor-implemented, with a particular processor or processors 1204 being an example of hardware. For example, at least some of the operations of a method may be performed by one or more processors 1204 or processor-implemented components. Moreover, the one or more processors 1204 may also operate to support performance of the relevant operations in a “cloud computing” environment or as a “software as a service” (SaaS). For example, at least some of the operations may be performed by a group of computers (as examples of machines 1200 including processors 1204), with these operations being accessible via a network 1232 (e.g., the Internet) and via one or more appropriate interfaces (e.g., an API). The performance of certain of the operations may be distributed among the processors 1204, not only residing within a single machine 1200, but deployed across a number of machines 1200. In some example embodiments, the processors 1204 or processor-implemented components may be located in a single geographic location (e.g., within a home environment, an office environment, or a server farm). In other example embodiments, the processors 1204 or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine 1200. A processor 1204 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor may further be a multi-core processor having two or more independent processors 1204 (sometimes referred to as “cores”) that may execute instructions 1210 contemporaneously.

What is claimed is:

1. A method comprising:
receiving, from a seller, data representing a window of time, the window of time including one or more periods of time for which a pickup of a physical item occurs at a location of the seller for a delivery of the physical item to a location of a buyer;
determining a second location corresponding to a different delivery of a different physical item by a driver, the different delivery occurring prior to the window of time;
selecting the driver, among a set of drivers, for delivery of the physical item based at least in part on a distance from the second location to the location of the seller and the window of time for the pickup of the physical item, and the driver is currently performing the different delivery of the different physical item when the driver is selected for the delivery of the physical item; and
in response to selecting the driver, adding the delivery in a queue of deliveries, the queue including the different delivery of the different physical item, for the driver during a particular day.

2. The method of claim 1, wherein each driver from the set of drivers has submitted a respective bid, corresponding to a respective cost for delivery, for delivery of the physical item.

3. The method of claim 2, wherein the respective bid associated with the driver has been selected to perform delivery of the physical item.

4. The method of claim 1, wherein selecting the driver, among the set of drivers, comprises:
for each driver from the set of drivers:
determining a particular location corresponding to a particular delivery of a particular physical item, the particular delivery occurring prior to the window of time; and
determining a respective distance from the particular location to the location of the seller.

5. The method of claim 4, further comprising:
determining that the respective distance of the driver is less than the respective distance of each other driver from the set of drivers.

6. The method of claim 1, wherein adding the delivery in the queue of deliveries further comprises:
determining at least one existing delivery in the queue; and
including the delivery in the queue as a subsequent delivery to the at least one existing delivery.

7. The method of claim 1, further comprising:
causing, on a client device, display of an interface including the queue of deliveries.

8. A system comprising:
one or more computer processors; and
one or more computer-readable mediums storing instructions that, when executed by the one or more computer processors, cause the system to perform operations comprising:
receiving, from a seller, data representing a window of time, the window of time including one or more periods of time for which a pickup of a physical item occurs at a location of the seller for a delivery of the physical item to a location of a buyer;
determining a second location corresponding to a different delivery of a different physical item by a driver, the different delivery occurring prior to the window of time;
selecting the driver, among a set of drivers, for delivery of the physical item based at least in part on a distance from the second location to the location of the seller and the window of time for the pickup of the physical item, and the driver is currently performing the different delivery of the different physical item when the driver is selected for the delivery of the physical item; and
in response to selecting the driver, adding the delivery in a queue of deliveries, the queue including the different delivery of the different physical item, for the driver during a particular day.

9. The system of claim 8, wherein each driver from the set of drivers has submitted a respective bid, corresponding to a respective cost for delivery, for delivery of the physical item.

10. The system of claim 9, wherein the respective bid associated with the driver has been selected to perform delivery of the physical item.

11. The system of claim 8, wherein selecting the driver, among the set of drivers, comprises:
for each driver from the set of drivers:
determining a particular location corresponding to a particular delivery of a particular physical item, the particular delivery occurring prior to the window of time; and
determining a respective distance from the particular location to the location of the seller.

12. The system of claim 11, the operations further comprising:
determining that the respective distance of the driver is less than the respective distance of each other driver from the set of drivers.

13. The system of claim 8, wherein adding the delivery in the queue of deliveries further comprises:
determining at least one existing delivery in the queue; and
including the delivery in the queue as a subsequent delivery to the at least one existing delivery.

14. The system of claim 8, the operations further comprising:
causing, on a client device, display of an interface including the queue of deliveries.

15. A machine-readable medium storing instructions that, when executed by one or more computer processors of one or more computing devices, cause the one or more computing devices to perform operations comprising:
receiving, from a seller, data representing a window of time, the window of time including one or more periods of time for which a pickup of a physical item occurs at a location of the seller for a delivery of the physical item to a location of a buyer;
determining a second location corresponding to a different delivery of a different physical item by a driver, the different delivery occurring prior to the window of time;
selecting the driver, among a set of drivers, for delivery of the physical item based at least in part on a distance from the second location to the location of the seller and the window of time for the pickup of the physical item, and the driver is currently performing the different delivery of the different physical item when the driver is selected for the delivery of the physical item; and
in response to selecting the driver, adding the delivery in a queue of deliveries, the queue including the different delivery of the different physical item, for the driver during a particular day.

16. The machine-readable medium of claim 15, wherein each driver from the set of drivers has submitted a respective bid, corresponding to a respective cost for delivery, for delivery of the physical item.

17. The machine-readable medium of claim 16, wherein the respective bid associated with the driver has been selected to perform delivery of the physical item.

18. The machine-readable medium of claim 15, wherein selecting the driver, among the set of drivers, comprises:
for each driver from the set of drivers:
determining a particular location corresponding to a particular delivery of a particular physical item, the particular delivery occurring prior to the window of time; and
determining a respective distance from the particular location to the location of the seller.

19. The machine-readable medium of claim 18, the operations further comprising:
determining that the respective distance of the driver is less than the respective distance of each other driver from the set of drivers.

20. The machine-readable medium of claim 15, wherein adding the delivery in the queue of deliveries further comprises:
determining at least one existing delivery in the queue; and
including the delivery in the queue as a subsequent delivery to the at least one existing delivery.

21. A method comprising:
receiving a selection, via a user interface of an electronic application, for a delivery of a physical item to a location of a buyer within a period of time within a same day;
determining a group of drivers that are within a radius from a location of a seller of the physical item;
for each driver from the group of drivers:
determining a particular cost for the delivery based at least in part on a respective rate of each driver and a distance from the location of the buyer to a second location of the seller of the physical item;
determining a particular time for the delivery of the physical item based on a particular distance from a current location of each driver to the second location of the seller and from the second location to the location of the buyer; and
generating a list of available drivers, the list of available drivers including information indicating the particular cost for the delivery and the particular time for the delivery for each driver from the group of drivers.

22. The method of claim 21, further comprising:
for each driver from the group of drivers:
determining a particular time for a pickup of the physical item at the second location of the seller based at least in part on the current location of each driver; and
including the particular time for the pickup of the physical item as additional information in the list of available drivers.

23. The method of claim 22, further comprising:
causing, in the user interface of the electronic application, a display of the list of available drivers;
receiving a second selection of one of the available drivers in the list of available drivers;
sending a request for fulfilling the delivery to the one of the available drivers; and
receiving a message confirming the request.

24. The method of claim 23, wherein the current location of the one of the available drivers is further away than the current location of another driver from the available drivers.

25. The method of claim 23, wherein the respective of the one of the available drivers is less than the respective rate of another driver from the available drivers.

26. The method of claim 21, wherein the respective rate is based on a function of a distance for delivery of the physical item and a monetary cost per unit of distance.

27. The method of claim 26, wherein the monetary cost per unit of distance is configured based at least in part on a setting associated with a particular driver.

28. A system comprising:
one or more computer processors; and
one or more computer-readable mediums storing instructions that, when executed by the one or more computer processors, cause the system to perform operations comprising:
receiving a selection, via a user interface of an electronic application, for a delivery of a physical item to a location of a buyer within a period of time within a same day;
determining a group of drivers that are within a radius from a location of a seller of the physical item;
for each driver from the group of drivers:
determining a particular cost for the delivery based at least in part on a respective rate of each driver and a distance from the location of the buyer to a second location of the seller of the physical item;
determining a particular time for the delivery of the physical item based on a particular distance from a current location of each driver to the second location of the seller and from the second location to the location of the buyer; and
generating a list of available drivers, the list of available drivers including information indicating the particular cost for the delivery and the particular time for the delivery for each driver from the group of drivers.

29. The system of claim 28, the operations further comprising:
for each driver from the group of drivers:
determining a particular time for a pickup of the physical item at the second location of the seller based at least in part on the current location of each driver; and
including the particular time for the pickup of the physical item as additional information in the list of available drivers.

30. The system of claim 29, the operations further comprising:
causing, in the user interface of the electronic application, a display of the list of available drivers;
receiving a second selection of one of the available drivers in the list of available drivers;
sending a request for fulfilling the delivery to the one of the available drivers; and
receiving a message confirming the request.

31. The system of claim 30, wherein the current location of the one of the available drivers is further away than the current location of another driver from the available drivers.

32. The system of claim 30, wherein the respective of the one of the available drivers is less than the respective rate of another driver from the available drivers.

33. The system of claim 32, wherein the respective rate is based on a function of a distance for delivery of the physical item and a monetary cost per unit of distance.

34. The system of claim 33, wherein the monetary cost per unit of distance is configured based at least in part on a setting associated with a particular driver.

35. A machine-readable medium storing instructions that, when executed by one or more computer processors of one or more computing devices, cause the one or more computing devices to perform operations comprising:
receiving a selection, via a user interface of an electronic application, for a delivery of a physical item to a location of a buyer within a period of time within a same day;
determining a group of drivers that are within a radius from a location of a seller of the physical item;
for each driver from the group of drivers:
determining a particular cost for the delivery based at least in part on a respective rate of each driver and a distance from the location of the buyer to a second location of the seller of the physical item;
determining a particular time for the delivery of the physical item based on a particular distance from a current location of each driver to the second location of the seller and from the second location to the location of the buyer; and
generating a list of available drivers, the list of available drivers including information indicating the particular cost for the delivery and the particular time for the delivery for each driver from the group of drivers.

36. The machine-readable medium of claim 35, the operations further comprising:
for each driver from the group of drivers:
determining a particular time for a pickup of the physical item at the second location of the seller based at least in part on the current location of each driver; and
including the particular time for the pickup of the physical item as additional information in the list of available drivers.

37. The machine-readable medium of claim 36, the operations further comprising:
causing, in the user interface of the electronic application, a display of the list of available drivers;
receiving a second selection of one of the available drivers in the list of available drivers;
sending a request for fulfilling the delivery to the one of the available drivers; and
receiving a message confirming the request.

38. The machine-readable medium of claim 37, wherein the current location of the one of the available drivers is further away than the current location of another driver from the available drivers.

39. The machine-readable medium of claim 37, wherein the respective of the one of the available drivers is less than the respective rate of another driver from the available drivers.

40. The machine-readable medium of claim 39, wherein the respective rate is based on a function of a distance for delivery of the physical item and a monetary cost per unit of distance.
